(19) United States
(12) Patent Application Publication
(10) Pub. No.: US 2018/0308174 A1
(43) Pub. Date: Oct. 25, 2018

(54) SYSTEM AND METHOD FOR IDENTIFYING, MONITORING AND MITIGATING RISKS

(71) Applicants: Shruthi Nagaraja Rao, New York, NY (US); Sandeep Chandur Ravi, New York, NY (US)

(72) Inventors: Shruthi Nagaraja Rao, New York, NY (US); Sandeep Chandur Ravi, New York, NY (US)

(73) Assignee: Adapt Ready Inc., New York, NY (US)

(21) Appl. No.: 15/496,076

(22) Filed: Apr. 25, 2017

(51) Int. Cl. G06Q 40/08

(52) U.S. Cl. CPC G06Q 40/08

(57) ABSTRACT

A system (100) and method (500) for identifying, monitoring and mitigating risks is provided. The system (100) is configured to receive information corresponding to a first entity and one or more entities that operate in association with the first entity. The system (100) identifies a plurality of risks having an impact on the operation of the first entity based on understanding of the first entity's exposure to risk from extreme events by processing at least a portion of the information received. The system (100) is further configured to notify the first entity of the identified risks, wherein the notification is communicated to the first entity through the system (100) by a second entity that provides service to the first entity. Risk mitigation plans may be provided to the first entity to mitigate impacts of the risks, wherein the risk mitigation plans are communicated to the first entity through the system (100) by the second entity that provides service to the first entity. Pursuant to a risk mitigation plan being applied by the first entity to avoid or mitigate impacts of the risk, such application and resulting outcome are communicated to the second entity through the system (100) by the first entity that uses the service of the second entity.

### BACKGROUND

Unless otherwise indicated herein, the materials described in this section are not prior art to the claims in this application and are not admitted to be prior art by inclusion in this section.

### Field

The subject matter in general, relates to risk identification, mitigation and management. More particularly the subject matter relates to risk identification and mitigation in the field of insurance.

### Discussion of Related Art

Risk identification and management are critical processes. Business entities are required to plan and prepare strategies in advance to mitigate losses resulting from events that invite risks. There exist systems and methods for monitoring risks mostly based on weather related parameters and historical events, among other factors. Conventional systems and methods accordingly provide generic adaptation strategies to cope with the situations that may result from such risks.

Insurance companies provide protection from loss of income to business entities. Loss of income may be due to risks resulting from unexpected events such as weather hazard, natural disaster, fire, geopolitical events, confiscation of property, strike, currency fluctuation, marine incident, cyber incident or the indirect impact of an act of terrorism or political violence that can result in large losses. Protection from such impacts is typically provided through business interruption (BI) and contingent business interruption (CBI) insurance. Business interruption insurance products are typically underwritten by an insurer after considering various aspects of the business to be insured, including the size of the business, the locations that it conducts business in, risk factors at those locations, building standards (e.g. fire safety standards maintained in the facility), historical events that resulted in physical, financial or other impact, and other related meta-data.

Further, a business entity may have plurality of associated businesses such as, raw material suppliers, finished goods suppliers, manufacturing units, loan providers, distributors and transportation entities, retail shops, among others. Furthermore, each of these associated businesses may be operating at multiple locations. Probable risks may arise from various factors related to the locations of the associated entities and historical risk events, among others. Business entities may be substantially affected as a result of risk exposure of their associated businesses.

Most often, business entities may be covered by different insurance products. The extent of protection may depend upon the terms and conditions of the insurance. Under certain scenarios, an insured client may not even be aware of what kind of damages are covered by an insurance policy. Currently, once an insurance product is sold to a business, there is very little communication between the insurer and the insured until the point when it is time to file a claim. Hence, it becomes difficult for an entity to plan or determine appropriate risk mitigation, management or adaptation strategies without fully understanding or knowing the claims of an insurance and/or without proper notification from the insurer and/or knowing about the potential risk which may not have been identified before.

For large insurance clients (e.g. clients with over $1 bn in annual turnover), the insurer may have a special risk advisory service, that is either sold separately or included in the policy. However, from an on-going, continuously evolving risk perspective, the insurer does not provide any tool for monitoring risks and planning strategies on a continuous basis. Moreover, existing risk management tools rely on static data or historical data, without taking into account the dynamic and evolving nature of risk.

Further, different clients may require different adaptation strategies based on their types, based on the criticality of risks and based on the type of insurance products sold to the clients.

In light of the foregoing discussion there is a need for a technique for providing customized risk identification and adaptation strategies to business entities on a frequent basis, considering all possible risk factors which may impact their business in the years to come.

### SUMMARY

An embodiment discloses a system identifying, monitoring and mitigating risks. The system is configured to receive information corresponding to a first entity and one or more entities that operate in association with the first entity. The system identifies a plurality of risks having an impact on the operation of the first entity based on understanding of the first entity's exposure to risk from extreme events by processing at least a portion of the information received. The system is further configured to notify the first entity of the identified risks, wherein the notification is communicated to the first entity through the system by a second entity that provides service to the first entity. Risk mitigation plans may be provided to the first entity to mitigate impacts of the risks, wherein the risk mitigation plans are communicated to the first entity through the system by the second entity that provides service to the first entity.

Another embodiment discloses a system and method monitoring and mitigating risks. The system comprises an enrolment module, a database module, a notification module, a risk assessment module, an analytics module and a privacy module. The enrolment module is configured to enable a second entity to enroll a first entity to the system, wherein the first entity is allowed to access the system and share information with the system upon enrolment by the second entity. The database module comprises information corresponding to a plurality of entities, plurality of risks, plurality of risk mitigation plans and plurality of insurance products. The notification module notifies the first entity and the second entity of risks that are likely to have an impact on the operation of the first entity. The risk assessment module identifies a plurality of risks that are inferred to have an impact on the operation of the first entity, by processing at least a portion of information received. The analytics module is configured to determine risks which are critical to the operations of the first entity. The privacy module enables the first entity to control information corresponding to the first entity.

Another embodiment discloses a system and method for identifying, monitoring and mitigating risks. The method comprises receiving information corresponding to a first entity and one or more entities that operate in association with the first entity. The method identifies a plurality of risks having an impact on the operation of the first entity based on understanding of the second entity's exposure to risk from extreme events by processing at least a portion of the information received. The method further comprises notifying the first entity of the identified risks, wherein the notification is communicated to the second entity through the system by the second entity. The method enables providing risk mitigation plans to the first entity to mitigate impacts of the risks, wherein the risk mitigation plans are communicated to the first entity through the system by the second entity.

### BRIEF DESCRIPTION OF DRAWINGS

Embodiments are illustrated by way of example and not limitation in the Figures of the accompanying drawings, in which like references indicate similar elements and in which:

FIG. 1 is a block diagram illustrating exemplary architecture of a system 100 for monitoring and mitigating risks;

FIG. 2 a block diagram illustrating a database module 102 of the system 100 of FIG. 1;

FIG. 3 a block diagram illustrating a risk assessment module 106 of the system 100 of FIG. 1;

FIG. 4, is a block diagram illustrating exemplary communication between a system 100 a plurality of first entities and a second entity;

FIG. 5 is a flowchart 500 illustrating an exemplary method for monitoring and mitigating risks;

FIG. 6 is a flowchart 600 illustrating an exemplary method for determining risks which are critical to an entity;

FIG. 7 is a flowchart 700 illustrating an exemplary method for notifying entities of risks that are likely to impact an entity;

FIGS. 8A and 8B is a flowchart 800 illustrating an exemplary method for providing risk mitigation plans and proposing insurance products to entities; and

FIG. 9 is a flowchart 900 illustrating an exemplary method for calculating risks.

### DETAILED DESCRIPTION

### I. OVERVIEW

### II. SYSTEM MODULES

### III. COLLECTING RISKS ARISING FROM VARIOUS FACTORS

### IV. EXEMPLARY METHOD FOR MONITORING AND MITIGATING RISKS

### V. METHOD FOR DETERMINING CRITICAL RISKS

### VI. METHOD FOR NOTIFYING RISKS TO ENTITIES

### VII. METHOD FOR PROVIDING RISK MITIGATION PLANS TO ENTITIES

### VIII. CONCLUSION

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### I. OVERVIEW

An embodiment provides a system for identifying, monitoring and mitigating risks. The system notifies one or more entities of any possible risks which may affect their business and, based on the risks, provides strategies to mitigate or overcome risks. The system may be designed for entities such as insurers with whom several business entities may have been insured through various insurance products and requires the system to monitor risks for each type of business entities insured through different insurance products and provide customized risk mitigation plans to each client (first entity). The system includes an enrolment module, which enables an insurer (second entity) to provide, to the first entity, access to the system. The second entity enrolls or registers one or more first entities, who may or may not be insured with the second entity, with the system such that the first entity may share information corresponding to the first entity with the system upon enrolment. The system enables the first entity to apply privacy control settings to at least a portion of information provided. The privacy settings may be enabled through a privacy module within the system. The system includes a web crawling module configured to collect information corresponding to the first entity, from sources external to the first and second entities. The system may determine whether any information collected through the web crawling module has been tagged with privacy control settings.

The system includes a risk assessment module configured to identify a plurality of risks that are inferred to have an impact on the operation of the first entity, by processing at least a portion of information received from the first entity. An analytics module is configured to determine criticality of risks based on a predetermined threshold value, which may be based on the service contract between the first and second entities. Risks that are critical to the operations of the first entity have a higher negative impact on the operations of the first entity compared to risks that are not considered critical. A notification module enables notifying the first entity of the critical risks that are likely to have an impact on the operation of the first entity. The system also includes a database module comprising a plurality of risk mitigation plans, insurance products, types of entities, and risks, among other information. Risk mitigation plans may be customized based on the type of the first entity, type of insurance product and criticality of the risks, among others. Notification corresponding to the risk is communicated to the first entity through the system by the second entity. Further, the system provides risk mitigation plans to the first entity to mitigate impacts of the risks, wherein the risk mitigation plans are customized based on the type of insurance products that a first entity may be insured with.

### II. SYSTEM MODULES

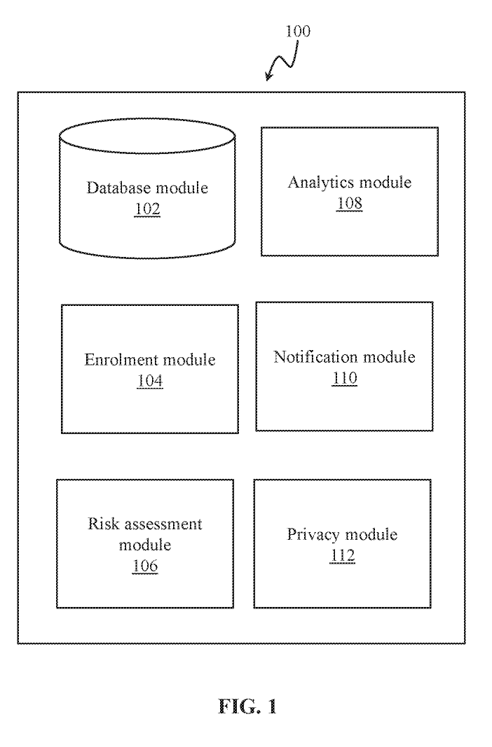

Referring to the figures, more particularly to FIG. 1, an exemplary architecture of an exemplary system 100 for monitoring and mitigating risks is provided. System 100 may include a database module 102, an enrolment module 104, a risk assessment module 106, an analytics module 108, notification module 110 and a privacy module 112. The system 100 may further include additional modules that might be required to enhance operation of the system 100.

System 100 is accessible by a first entity and a second entity. The system 100 may be designed to meet requirements of a second entity, such as need for providing information regarding risks to their business clients or prospects (first entity). The second entity may be an insurance service provider or an insurer. It shall be noted that the term insurance service provider or insurer may include an insurance company, a re-insurance company, an insurance intermediary (e.g. broker), insurance underwriters or an agency that sells insurance policies to customers on behalf of the insurance company.

The first entity may be a business entity insured with the second entity or a prospect for the second entity. The first entity can be a corporation, a multinational company, a LLC, a LLP, partnership, city government, state government, federal government, school, hospital, and dependents of such an entity, including, but not limited to, its manufacturing plants, suppliers, vendors, warehouses, and so on. There may be various types of first entities (corporate customers, individuals, etc.) that the second entity insures. The second entity may have distinct policies, claim coverages, added services, etc. for different types of entities. First entities may be grouped into several groups by the second entity using system 100 at least based on the type of policies and claims coverage.

The system 100 may reside within computing. System 100 may be an application software that uses the computing device's hardware in order to perform operations. System 100 may be a web application. In an embodiment, the system 100 may provide a plug-and-play interface (cloud-based) to enable continuous risk monitoring without the need to install additional software onto the insurer's (second entity) or the insured's (first entity) computing devices.

In another embodiment, the system 100 may be deployed on a remote server. In yet another embodiment, a portion of the system 100 may be deployed on a remote server and another portion of the system 100 may be hosted on the computing devices of the entities.

The system 100 includes a plurality of modules. Each of the modules may, independently or in combination with other modules of system 100, enable system 100 to identify a plurality of risks having an impact on the operation of the first entity, notify the first entity of the identified risks and provide risk mitigation plans to the first entity to mitigate impacts of the risks.

The database module 102 may be included in the computing device's memory/storage. Alternatively, the system 100 may have access to a database module 102, which may be hosted on a cloud server at a remote location, through a wired or wireless connection.

The database module 102 may include data pertaining to but not limited to different types of first entities and their associated entities, list of risks which may affect the business of the entity and their associated entities, historical data pertaining to risks faced by one or more first entities, risk mitigation plans adopted or implemented to overcome corresponding risks, historic data pertaining to risk mitigation plans adopted or implemented as per geographical location to overcome risks, historical data pertaining to risk mitigation plans adopted or implemented by specific industries to overcome risks, historical data pertaining to risk mitigation plans adopted or implemented by specific type of first entity to overcome risks, historic weather data, weather forecast data, climate forecast data, political reporting data, statistical and predictive model data, economic reporting data and data internal and exclusive to the entity (such as claims histories), among others. The database module 102 may further include information corresponding to insured, uninsured or underinsured entities associated with the insured first entity.

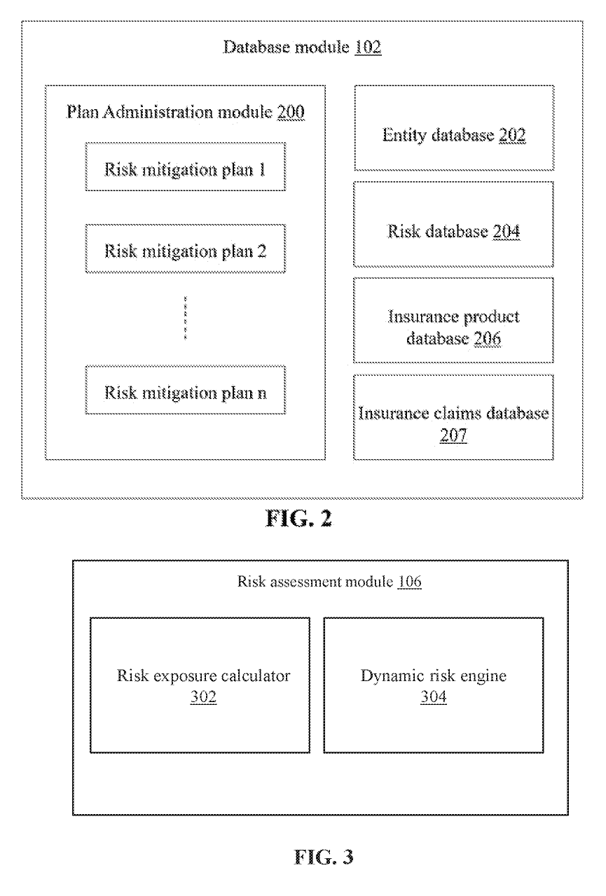

Referring to FIG. 2, the database module 102 may further include a plan administration module 200, an entity database 202, risk database 204 and an insurance product database 206. The plan administration module 200 may further include plurality of risk mitigation plans. The entity database 202 may include information corresponding to first entities including entities which are insured with the second entity and entities which may be prospects to the second entity. Risk database 204 includes information corresponding to risks related to various factors. Insurance product database 206 stores information corresponding to the insurance products wherein insurance products are created based on identified risk exposures, probable losses, and spread of risk, and market them to insured clients and/or new prospects. Further, the database module 102 stores data corresponding to change in the risks critical to the functioning of an entity, over time. The database module 102 stores the dynamically changing risk profiles corresponding to entities. The plan administration module 200, the entity database 202, risk database 204 and the insurance product database 206 may be populated from one or more master databases. The master databases may be global databases.

One or more of the risk mitigating plans may be stored as preconfigured templates. The plan administration module 200 may be configured to add new risk mitigation plans as and when new insurance products are created. Such risk mitigation plans may be stored as new templates. Furthermore, the system 100 may modify one or more of the existing risk mitigation plans. The plan administration module 200 stores the modified risk mitigation plans as new templates.

As an example, let's assume insurer A has customers B, C and D. B is insured under a product P1 that covers maximum damages likely to be caused by a risk X. C is insured under a product P2 that enables C to claim damages only under a few scenarios/damages likely to be caused by risk X. D is insured under a product P3 that enables D to claim damages only in case of risk Y, however risk X may also cause substantial damages to D. However, D is not covered under any product for the damages likely to be caused by risk X. For product P1 and risk X, there exists a risk mitigation plan M1. Likewise, for product P2 and risk X, there exists a risk mitigation plan M2. However, for product P3 and risk X, there does not exist a mitigation plan. The system 100 accesses the database module 102 and may create a new risk mitigation plan M3 for product P3 and risk X.

Risk mitigation plans may be modified and customized based on the insurance products. Risk mitigation plans may be modified and customized based on the entities and the type of insurance products they are insured with. Risk mitigation plans may be modified and customized based on the entities' nature of business, geography and climatic conditions, among others. Risk mitigation plans may be modified and customized based on entities associated with the first entity. Risk mitigation plans may be modified and customized based on the criticality of the risks. Examples of risk mitigation plans may include, installation of sand bags at a manufacturing plant on an event of flood, among others.

In an embodiment, risk mitigation plans may be based on one or more of historical risk mitigation plans adopted in a geographical location, historical risk mitigation plans adopted in an industry, and historical risk mitigation plans adopted by an entity with a similar nature of business as the first entity.

The enrolment module 104 is configured to register or enroll a first entity with the system 100. Upon enrolment, the first entity is enabled to share information with the system and the second entity. In an embodiment, the second entity may enroll the first entity with the system 100 upon selection of an insurance product by the first entity or while contemplating purchase of an insurance product.

In an embodiment, the system 100 may include a platform or a user interface through which information may be provided to the system 100 and interaction may be enabled between the first and the second entity. The system 100 receives information corresponding to the first entity from the first entity. System 100 may also receive information corresponding to entities associated with the first entity, such as raw material suppliers, manufacturers, transportation entities, distributors and loan providing entities, among others.

In an embodiment, the system 100 allows the first entity to disclose as much information as the first entity wishes. The system 100 allows the first entity to apply privacy settings on some types of data that the system 100 may be asking through the platform or the user interface, such that, once privacy is set, the system 100 is allowed to use said data in a manner that complies with the privacy settings.

In another embodiment, system 100 further includes a web crawling module (not shown) configured to gather information corresponding to the first entity, entities associated with the first entity and aspects affecting the business of such entities. The web crawling module may be configured to gather information, from external sources. The privacy settings may also define what kind of information provided by the first entity can be used to determine the web crawling logic.

The system 100 includes a privacy module 112, which enables the first entity to apply data privacy control to certain information, defining the manner in which such data can be used by the system 100. Further, the system 100 is configured to refrain from sharing, with the second entity or any other entity, information that has the privacy control setting. Information that the first entity sets or tags as private may include, but not limited to, information corresponding to associated entities, internal security and employees, among others. The privacy module 112 ensures the security of the first entity's competitive advantage and other business sensitive information, while still allowing for the assessment of risk profiles to get deeper insight into the first entity's risk exposure.

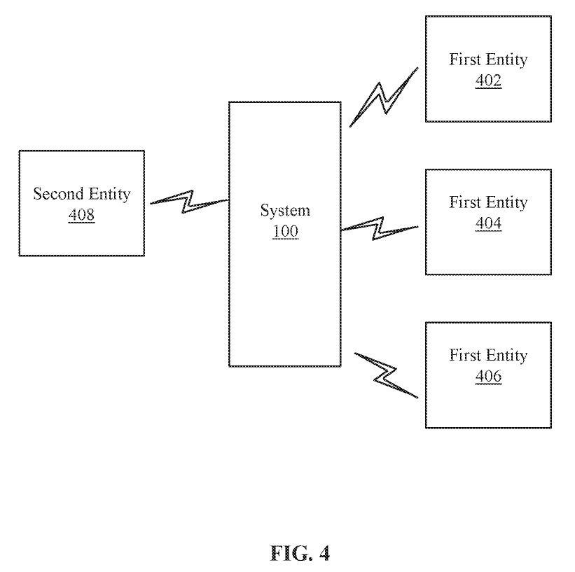

Referring to FIG. 3, the risk assessment module 106 may be configured to determine risks which may be critical to the business of the first entity. The risk assessment module 106 may have access to the database module 102, where listing of risks pertaining to entity type and geographical location of the first entity, among other risks may be stored. Further, the risk assessment module 106 may be able to access the analytics module 108. The risk assessment module 106 may be configured to process the data stored in database module 102 pertaining to risks critical to the first entity and associated entities and determine which risks may be critical to the business of the entity.

The risk assessment module 106 may include a risk exposure calculator 302 and a dynamic risk engine 304. The exposure calculator 302 processes data and determine risks faced by the first entity. The risk exposure calculator 302 may be configured to determine the risks faced by the first entities, including any critical risks. The risk exposure calculator 302 may have access to the plan administrator module 200, wherein the risk mitigation plans may be modified and customized upon calculation of the criticality of a risk by the risk exposure calculator 302. Risks critical to the functioning of an entity may change over time. The dynamic risk engine 304 may be configured to determine and change the critical risks affecting an entity, as and when there is a change in the critical risks affecting the entity. The dynamic risk engine 304 may monitor the dynamically changing risk profiles for entities. The dynamic risk engine 304 may be configured to monitor data pertaining to all risks which may be faced by the first entity or associated entities. When the level of risk goes above a predetermined threshold value, the dynamic risk engine 304 may determine that, there are impending risks to be faced by the first entity or one or more of associated entities. The dynamic risk engine 304 processes data and determine if there are impending risks, including any critical risks. The risk assessment module 106 may have access to the notification module 110.

The risk assessment module 106 is further configured to identify interconnected risks, such as a risk likely to affect the normal operation of two or more entities insured with the second entity and associated with a common entity (e.g. supplier), wherein the risk is critical to the associated entity. In an example, an entity A may be a car manufacturer operating at location G1. Let's suppose another entity B may also be a car manufacturer operating at another location G2. However, each of the entity has a common raw materials supplier operating at location G3. Now if G3 encounters an earthquake or a volcanic eruption, then risks to both the entities A and B are of the same level. The second entity has to cover damages incurred by entities A as well as B based on the type of insurance products each entity held.

The threshold value of a risk may be a numerical value, a rating or a score. The threshold may be derived from a number of factors, including external and internal factors. External factors may include historical data related to geographical risks, environmental risks including weather and climatic conditions, risks from political events, risks from economic conditions, and so on. Internal factors may include historical data related to historical financial losses, number of days to recovery, number of impacted employees, number of days of loss of production, access to capital (including, but not limited to, loans from financial institutions, governments, and any other third parties), access to insurance among others. The threshold may change with respect to time and several other factors. The database module 102 is further configured to store threshold values for risks for each type of entities based on their geography, social, economic and political condition of that geography and climatic conditions of that geography

The analytics module 108 may be configured to access information from the risk assessment module 106 and the database module 102. The analytics module 108 defines risks as highly critical and/or not critical based on the threshold value. The analysis may be performed for different entities or a group of entities separately. When the level of particular risks go above the predetermined threshold value, for an entity or a group of entities, then the risk may be declared as highly critical. Further, when the level of particular risks fall below the predetermined threshold value, for an entity or a group of entities, then the risk may be declared as not critical. There may be intermediate levels of risks, such as moderately critical, less critical, etc. defined by the analytics module 108. The highly critical risks have a higher negative impact on the operations of the entities compared to risks that are not critical. Further, the analytics module 108 may provide scores to the levels of risks. The scores may be shared with the notification module 110.

Analytics module 108, in one embodiment, may further be configured to identify areas of risks that are uninsured and/or underinsured, meaning that an insurance product currently held by an entity does not cover one or more impending risks to a substantial extent. Such risks may result from events, which may be occurring in the future. for example, events, such as a dam being built. Such risks may be referred to as hidden risks and may not have been uncovered during formulation of the insurance products, either during an initial underwriting or subsequent renewal of the policy. Such risks may not have been listed in the risk database 206. Analytics module 108 may be configured to uncover such hidden (impending) risks from sources external to the entity. Sources of information may include satellite images, news, etc. Hidden risks resulting from forthcoming events may be analysed at various interconnected points and highlights missing gaps. The analytics module 108 may run extensive analytics to determine the missing gaps, which may require additional coverage. Upon determining the missing gaps, new insurance products may be created or existing insurance products may be modified to ensure such risks are covered.

The notification module 110 may have access to but not limited to the risk assessment module 106, the database module 102 and the analytics module 108. The notification module 110 may be configured to issue alerts to the entities, of impending risks, and dynamically changing risk profiles. The notification module 110 may be configured to issue notification to the entities by means of one or more of email, text message and web application notifications, cellular phone alerts, fax, and alerts through mobile applications, among other notification channels.

In an embodiment, the notification module 110 may be configured to notify an entity about risks that are likely to affect the entity and associated entities, risk mitigation plans corresponding to the identified risks that are likely to affect the entity and associated entities. The notification module 110 further, sends notification to the entity about whether the entity's current insurance product covers that risk. The notification module 110 may be configured to identify hidden risks which were not uncovered during formulation of the insurance products and their impact on the entity. The notification module 110 may be configured to notify about new insurance products created by the system 100 to one or more of the first entities (insured with the second entity) or to new prospects.

The notification module 110 may be configured to communicate alerts to the first entity in a predetermined time frame or when there is an urgent alert to be communicated to the first entity. The time frame of receiving alerts can be set by either the first entity or the second entity. For example, the time frame can be set to receive weekly alerts, monthly alerts, alerts when there is an impending risk or alerts when the impending risk is highly critical. The notification module 110 may be further configured to determine if the first entity has acknowledged the receipt of the alert. If first entity has not acknowledged the receipt of the alert, the notification module 110 can be configured to resend the alert until an acknowledgment is received.

In one embodiment, the system 100 communicates notifications to the first and the second entities. The notification module 110 further communicates the risk mitigation plans to the first entities. In another embodiment, the system 100 communicates notifications to the second entity and enables the second entity to notify the first entity of the risks along with the risk mitigation plans through system 100.

The system 100 further includes a first entity dashboard and a second entity dashboard. The first entity dashboard includes the entity's profile which shows the information that the first entity has provided to the system 100. The first entity dashboard may include different controls that the first entity is provided within the system. The controls may include data privacy setting control that enables the first entity to set information as private. The first entity may be enabled to control the data included in the profile. The first entity may further be enabled to control the notifications the first entity may receive.

Likewise, the second entity dashboard includes the entity's profile which shows the information that the second entity has provided to the system. The second entity dashboard may further include profiles of different customers (first entity) who may be insured or may be prospects for the second entity. The second entity dashboard further includes information corresponding to different insurance products, risks and risk mitigation plans, among others. The second entity dashboard includes different controls that the second entity is provided within the system. The second entity may be enabled to control the data in the profile including risks, risk mitigation plans, first entities, insurance products and so on. The second entity may further be enabled to control the notifications the second entity may receive from the system 100 and the notifications that need to be communicated to the first entity.

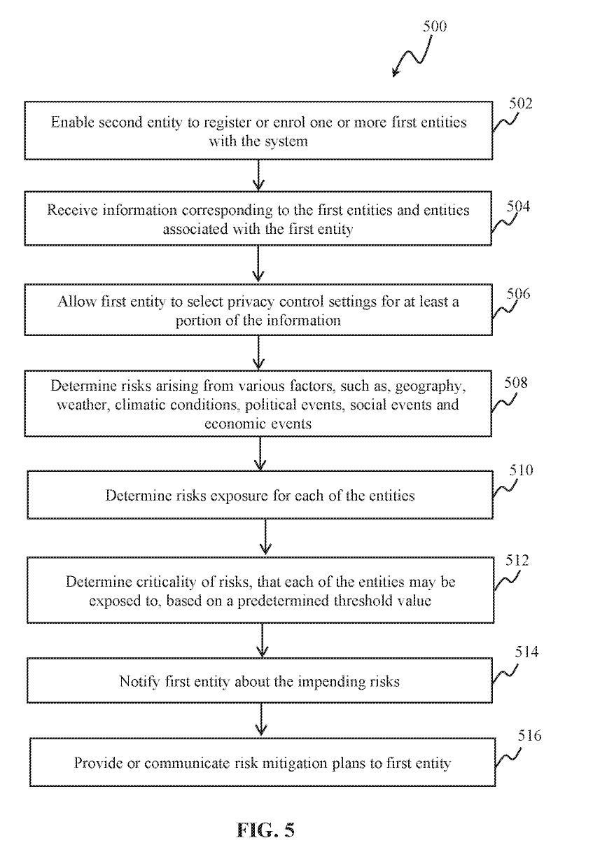

In an embodiment, the system 100 may be deployed on a remote server such as cloud. FIG. 4, is a block diagram illustrating exemplary communication between a system 100 a plurality of first entities and a second entity. The system 100 may be configured to communicate with the first entities and the second entity through communication network. The network may be internet, a wireless network, a wired network and a LAN network among other networks configured to facilitate communication. The system 100 may include software to enable communications over the network such as HTTP, TCP/IP protocols etc. In alternative embodiments of the present invention, other communication software and transfer protocols may also be used, for example IPX, UDP or the like.

The first entities can be, for example, represented by blocks 402, 404 and 406. The second entity may be represented by block 408. The first entities can be in communication with their associated entities and vice versa. The data pertaining to the associated entities which may be relevant to the business of the first entity may be communicated to the system 100 by the first entity or both the first entity and the associated entity. The first entity may have associated entities in multiple geographical locations. The first entity may receive data from all its associated entities. Upon receiving the data, the system 100 may store the data in the database module 102 and process the data to communicate relevant information to the entities. The information communicated from the system 100 to the entities may be alerts relating to risks and risk mitigation plans. The information may be communicated from the system 100 to the first entity and the second entity. Further, modified and updated information may be communicated by the second entity through the system 100 to the first entities.

Entities associated with first entities may be located in various geographical locations. The first entities may have manufacturing plants at different locations, suppliers at two or more locations and contactors at various locations, among others. For example, the geographical locations of the associated entities may be different from the location of the first entity. As a result, the risks faced by the associated entities may be different, owing to their different geographical locations. The risks impacting the first entities and their business may be due to change in weather, climatic aberrations, natural disasters or any external possibility for example, predictable, unpredictable environmental aberrations, natural or man-made disasters, economic and political changes, among other factors. The risks faced by the first entity and their associated entities may differ based on different factors affecting the entities owing to their geographical location and nature of business. The system 100 may be configured in such a way as to identify a location of each of the first entities and associated entities, analyse their interdependence, analyse impact of external and internal factors on them and calculate a risk exposure score for each of them individually and independently.

Information corresponding to the first entity, its locations, associated entities, their locations may be received from the first entity or by means of web crawling. For example, a geographical region G1 may suffer issues related to weather and climate such as snow, thunderstorms, and heat waves, among others. Similarly, geographical region G2 may suffer issues related to political and economic instability, among others. In such cases, the risks faced by the entities and their implications differ. Further, the same risk event may have a different impact on different entities. For example, in geographical region G1, associated entities C1, C2 and C3 may be located. C1, C2 and C3 may be exposed to a flood event, however, C1 may be located at higher elevation than C2 and C3. Now, since C1 is at a higher elevation than the rest, the risk factor for C1 is relatively lower. Hence risk mitigation plans for C1 may be different from risk mitigation plans for C2 and C3. Furthermore, the same risk event may have a different level of risk impact on two different first entities or associated entities based on their specific function.

The risk exposure calculator 302 may calculate the risk exposure for the first entities and the associated entities and determine a score of the risk exposure. Further, the exposure may be communicated to the analytics module 108, wherein the criticality of the risk for each of the first entity and the associated entities are determined based on a predetermined threshold value.

### III. COLLECTING RISKS ARISING FROM VARIOUS FACTORS

A first entity and its associated entities may be present globally. The system 100 is configured to receive from the first entity or through web crawling, information corresponding to geographical location of the first entity and its associated entities. Historical records from multiple sources may be accessed to collect data corresponding to various risk factors, such as geography, weather and climate, related risks, environment (soil quality etc.) related risks, political event related risks and economic crisis related risks. For example, geographical location based risks may be risks such as earthquake prone area, area prone to volcanic eruptions, area prone to floods, area prone to fires, area prone to hurricanes, area prone to cyclones and area prone to tsunami, among others. There may arise risks which may be due to the location of the entity in such areas and may pose risk to the business of the entity, upon occurrence of any calamity in the geographical locations. There may be multiple consequences which may arise out of weather factors, these may relate to transportation and storage of material, transportation of employees to their work location, destruction of property, destruction of raw material, loss of goods, spoilage of goods, stoppage of work and reduction of production, among other consequences. Climate related risks may be long term climatic changes such as global warming, changing of temperature, changing of weather patterns, changing of ecosystems, rising sea levels, changing landscapes, increased risk of drought, decreasing ground water levels, increased risk of fire and increase risk of floods, among others. Risks arising out of climatic changes may have a long-term impact and may affect the business of the entities in the long term. Political risks may be related to, type of government at the geographical location, political instability, attitude of the government towards entities or an entity's government, tariffs, policies and regulations of the government and decision making ability of the government, among others. Further, risks which may arise out of war, acts of violence and acts of terrorism, among other such acts, which may have an impact on the businesses of the entities, may be collected. There may be consequences of such acts in the location or neighbouring locations of the entity. These consequences may result in unavailability of raw material, transportation of goods, influx of refugees, scarcity of fuel, unavailability of employees and danger and destruction of property, proximity to nuclear power plants, chemical plants, among others. Risks which may arise out of economic changes may include bankruptcy of an entity, fall of share prices, increase in prices of raw material, increase in price of fuel and economic policies of government, among other economic factors. Further, risks which may emerge due to internal decisions of the entity, such as worker strike at the entity, demand of excess wages by the employees, employee attrition, law suits, accidents, management failure and bad decisions, among other such factors may be collected. All collected risks may be stored in the database module 102 in the risk database 204.

### IV. EXEMPLARY METHOD FOR MONITORING AND MITIGATING RISKS

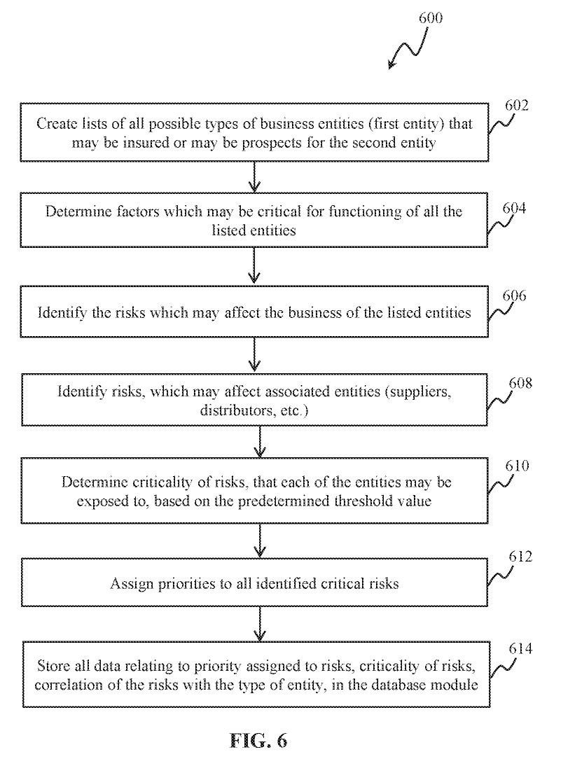

FIG. 5 is a flowchart 500 illustrating an exemplary method for monitoring and mitigating risks, which may affect the first entity. At step 502, the system 100 enables the second entity to register or enroll one or more first entities with the system 100. Upon enrolment, the first entities may be allowed to access the system 100 and communicate with the system 100 and the second entity through the system 100. At step 504, information corresponding to the first entities and entities associated with the first entity may be received by the system 100. Information corresponding to the first entities and entities associated with the first entity may be provided by the first entity. Further, information, which may not have been provided by the first entity may be received by the system 100 by means web crawling. At step 506, the system allows the first entity to tag at least a portion of the information as private. The privacy module 112 may be employed by the system 100 to maintain the privacy control settings for certain information. Further, the system 100 is configured to refrain from sharing information tagged with the privacy control. The system 100 also manages data received via web crawling, such that any portion of the data collected through web crawling if it were to fall within the scope of privacy control, the system does not utilize the data for determining risks and does not share such data with the second entity. At step 508, risks arising from various factors, such as, geography, weather, climatic conditions, political events, social events and economic events may be determined. At step 510, risks exposure for each of the entities (first entity and associated entities) may be determined. At step 512, criticality of risks, that each of the entities may be exposed to, is determined based on a predetermined threshold value. As an example, when the level of a particular risk goes above the predetermined threshold value, for an entity or a group of entities, then the risk may be declared as highly critical. Further, when the level of particular risks falls below the predetermined threshold value, for an entity or a group of entities, then the risk may be declared as not critical. There may be intermediate levels of risks, such as moderately critical, less critical, etc. The highly critical risks have a higher negative impact on the operations of the entities compared to risks that are not critical. At step 514, the first entity may be notified or alerted about the impending risks. In one embodiment, the system 100 communicates notifications to the first and the second entities. In another embodiment, the system 100 may notify the second entity and the first entity of the impending risk, wherein the second entity is enabled to communicate the notification about the impending risk to the first entity via the system 100. At step 516, the system 100 provides or communicates risk mitigation plans to the first entity. The system 100 may provide the risk mitigation plans to the second entity, wherein the second entity is enabled to communicate the risk mitigation plans to the first entity via the system 100. Examples of risk mitigation plans may include, installation of sand bags at a manufacturing plant due to a flood event (or anticipated flood event), among others.

### V. METHOD FOR DETERMINING RISKS

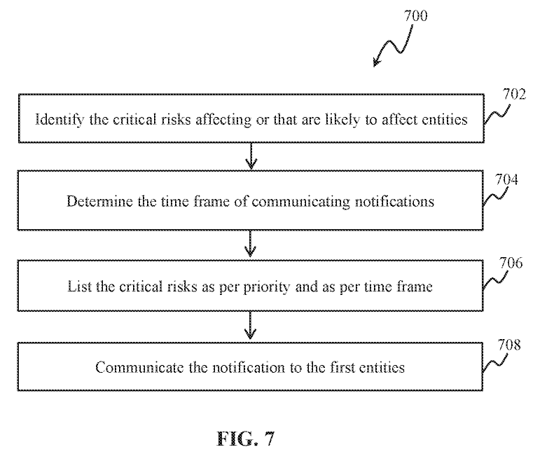

FIG. 6 is a flowchart 600 illustrating an exemplary method for determining risks which are critical to an entity. At step 602, lists of all entities (first entity) may be accessed from the entity database 202. The entities may be listed based on nature of business of the entities in the entity database 202. List of entities may be further stored or arranged in the database based on their global presence, annual turnover, number of employees and shares, among others. Further, entities may be listed based on the types insurance products they are insured under. For example, types of insurance products may be categorized mostly based on the terms and conditions of the insurance and the extent of damage coverage. At step 604, for all the listed entities, factors which may be critical for functioning of the entity may be determined. For example, factors which may be critical for functioning of the entity may depend upon the availability of raw materials and availability of skilled workers, transportation facility, quality of soil and weather, among others. At step 606, the risks which may affect the business of the entity may be identified. Risks may depend on the business of the entity and different risks may affect different entities. For example, for an entity involved in the manufacturing of rice, risks which may affect them may be quality of soil, rainfall, drought, etc. thereby affecting production and business. At step 608, risks, which may affect associated entities (suppliers, distributors, etc.) may be determined. At step 610, criticality of risks, that each of the entities may be exposed to, is determined based on the predetermined threshold value. At step 612, priorities may be assigned to the identified critical risks. All risks may not be critical. Some risks would be more critical than others. The prioritizing of risks may enable the entities to focus more on the risks which would have adverse impact on the business and strategize to overcome those risks. The prioritizing of risks may be carried out by the system 100. Alternatively, prioritizing of risks may be carried out manually at the backend. At step 614, all data relating to priority assigned to risks, criticality of risks, correlation of the risks with the type of entity, may be stored in the database module 102.

The system 100 further monitors the change in risks critical to the functioning of the entity over time. The system 100 stores the change in the critical risks affecting an entity, as and when there is a change in the critical risks affecting the entity. The change in critical risks affecting the entity may also change the risk mitigation plans to be adopted by the entity. The system 100 updates the database module 102 with the dynamically changing risk profiles.

### VI. METHOD FOR NOTIFYING ENTITIES OF CRITICAL RISKS

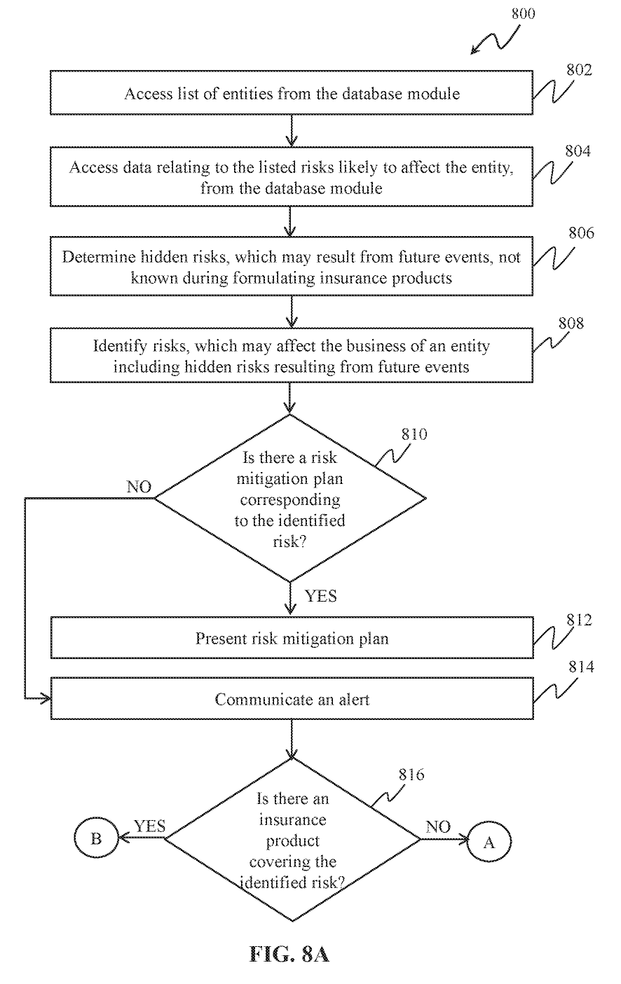

FIG. 7 is a flowchart 700 illustrating an exemplary method for notifying entities of risks that are likely to impact an entity. At step 702, the critical risks affecting or that are likely to affect entities may be identified as described in steps 606 and 608 above. At step 704, the time frame of communicating notifications or alerts to the entities may be determined. The time frame of communicating alerts may be chosen by the entities (first entity and second entity). At step 706, the critical risks may be listed as per priority as disclosed at step 614 above and as per time frame. At step 710, the system 100 communicates the notification to the first entities. If there are multiple risks with the same priority, which may be due in different time periods for example, 1 month, 6 months, 1 year, the risk which may affect the entity first may be listed at a higher order. In one embodiment, the system 100 communicates notifications to the second entity and enables the second entity to notify the first entity of the risks along with the risk mitigation plans. The system 100 may also communicate notifications to one or more associated entities.

### VII. METHOD FOR PROVIDING RISK MITIGATION PLANS TO ENTITIES

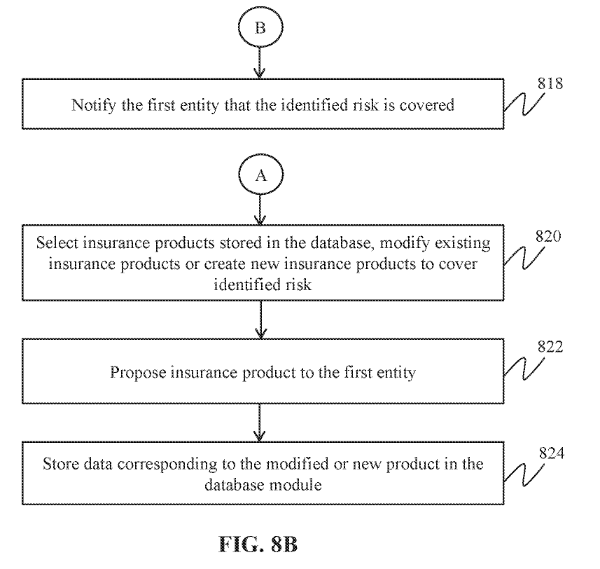

FIGS. 8A and 8B is a flowchart 800 illustrating an exemplary method for providing risk mitigation plans and proposing insurance products to entities. At step 802, list of entities may be accessed from the database module 102. List of entities may be stored or arranged in the database module 102 based on their type of business, global presence, annual turnover, number of employees and shares, among others. The list of entities may include both insured, underinsured and uninsured entities. At step 804, data relating to the listed risks likely to affect an entity, are accessed from the database module 102. At step 806, data relating to hidden risks, which may result from future events, not known during formulating insurance products, may be determined. At step 808, risks including hidden risks, which may be critical to the business of the entity may be identified. At step 810, it is determined if there exists a risk mitigation plan corresponding to the identified risk. If it is determined that there exists a risk mitigation plan corresponding to the identified risk, then at step 812, the risk mitigation plan may be presented to the first entity. The risk mitigation plan may be presented to the first entity and the second entity by the system 100, in one embodiment. In another embodiment, risk mitigation plan may be communicated to the second entity by the system 100 enabling the second entity to customize and present the risk mitigation plan to the first entity through system 100. If it is determined that there does not exist any risk mitigation plan corresponding to the identified risk, then at step 814, an alert may be communicated to the second entity. The alert may be communicated to the first entity and the second entity by the system 100, in one embodiment. In another embodiment, alert may be communicated by the second entity to the first entity through system 100. Further, if it is determined that there does not exist any risk mitigation plan corresponding to the identified risk, then simultaneously at step 816, it is determined if there is an insurance product covering the identified risk. If it is determined that there is an insurance product covering the identified risk, then at step 818, the system 100 notifies the first entity that the identified risk is covered. If it is determined that there is no insurance product covering the identified risk, then at step 820, an existing insurance product may be modified or a new insurance product may be created to cover the identified risk, including hidden risk(s). At step 822, the new insurance products or the modified insurance product may be proposed to the first entity. In an embodiment, the system 100 may be configured to pitch to the first entity to buy the modified or new insurance product. The proposal may be communicated to the first entity and the second entity by the system 100, in one embodiment. In another embodiment, proposal may be communicated by the second entity to the first entity through system 100. At step 824, data corresponding to the insurance product may be stored in the database module 102.

In an embodiment, the historical risk mitigation plans that may have been adopted for a specific risk by specific industries may be compiled and stored in the database module 102. Such compilation may be done by experts associated with the second entity. Risk mitigation plans may be correlated with risks. Risk mitigation plans may be correlated with the type of insurance products. Risk mitigation plans may be correlated with the type of entities. Such correlation may result in the system providing customized risk mitigation plans to entities. For example, for risk A1, for an entity B1 and with insurance C1, a risk mitigation plan R1 may be provided and so on.

In an embodiment, the system 100 may provide the second entity a plurality of risk mitigation plans to be communicated to the first entity. Further, the system 100 provides options to the second entity to select and/or customize one or more of the plurality of the listed risk mitigation plans to be communicated to the first entity.

The system 100 may further determine the first entity's capacity to adapt to risks, for the present state as well as for the future. For example, if the risk mitigation plans adopted by the entity to overcome the risks are not adequate, the system 100 may determine that, the entity has low capacity to adapt to risks. On the other hand, if the risk mitigation plans adopted by the entity to overcome risks are adequate, the system 100 may determine that, the entity has adequate or high capacity to adapt to risks.

The historical records, real-time data and forecast references may be taken from multiple sources. The system 100 reads historical records, real-time data and forecast references of each of the factors (influencing the entities directly or indirectly). All inputs may be processed to assess the impending risks. Based on these assessments, present and future adaptive capacities of the entity may be calculated.

### VIII. METHOD FOR CALCULATING RISKS

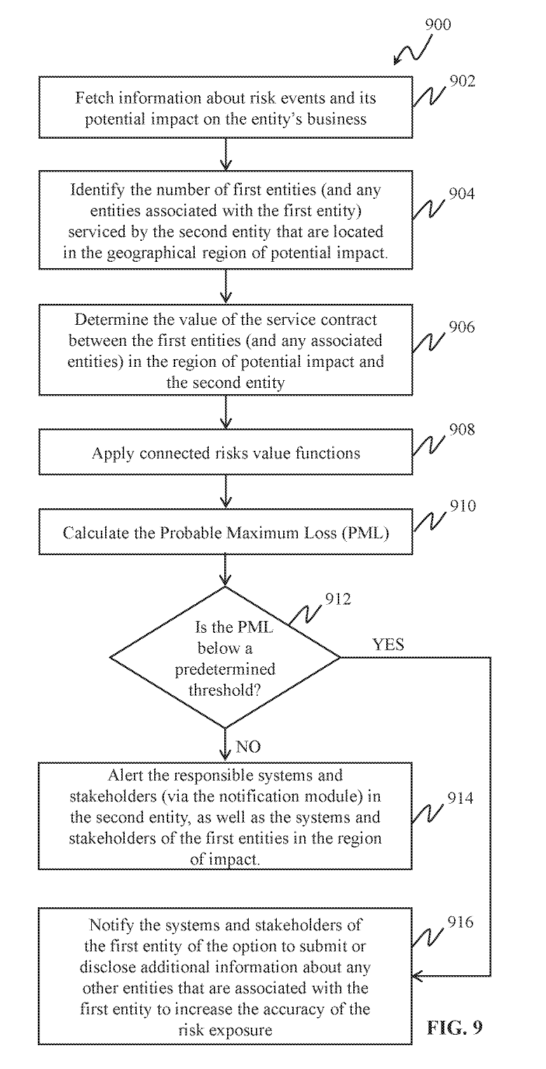

In an embodiment, system 100 further calculates a probable maximum loss PML an entity may face. FIG. 9 is a flowchart 900 illustrating an exemplary method for calculating risks. At step 902, information about risk events and its potential impact on the entity's business is fetched. At step 904, the number of first entities (and any entities associated with the first entity) serviced by the second entity that are located in the geographical region of potential impact is identified. At step 906, the value of the service contract between the first entities (and any associated entities) in the region of potential impact and the second entity is determined. At step 908, connected risks value functions are calculated. The connected risks value function is a set of weightages based mathematical and statistical functions that we have developed in order to calculate the potential and impact of interconnected risks in a distributed supply chain. Presently we treat this as trade secret. At step 910, the Probable Maximum Loss (PML) is calculated. At step 912, the system 100 determines, if the PML is below a predetermined threshold. At step 914, if it is determined that PML is below a predetermined threshold, the system 100 alerts the responsible systems and stakeholders (via the notification module) in the second entity, as well as the stakeholders of the first entities in the region of impact. At step 916, if its determined that PML is above a predetermined threshold, the system 100 notifies the stakeholders of the first entity of the option to submit or disclose additional information about any other entities that are associated with the first entity to increase the accuracy of the risk exposure.

### VIII. CONCLUSION

The system enables identification of risks that are likely to have an impact on entities.

The system notifies entities about the risks that are likely to have an impact on them.

The system automatically provides risk mitigation plans to overcome risks that are likely to have an impact on entities.

The system enables customization of risk mitigation plans based on the nature of business and the geography of an entity and the criticality of risks.

The system enables modification of risk mitigation plans and creation of risk mitigation plans based on the type of risks, the type of insurance products and based on the type of entities which are likely to be affected by the impending risks.

The system determines dynamically changing risk profiles.

The system further enables proposing insurance products to entities.

The processes described above is described as sequence of steps, but this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many examples, and these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A system for identifying, monitoring and mitigating risks, wherein the system is configured to:
receive information corresponding to a first entity and one or more entities that operate in association with the first entity;
identify a plurality of risks having an impact on the operation of the first entity based on understanding of the first entity's exposure to risk from extreme events by processing at least a portion of the information received;
notify the first entity of the identified risks, wherein the notification is communicated to the first entity through the system by a second entity that provides service to the first entity; and
provide risk mitigation plans to the first entity to mitigate impacts of the risks, wherein the risk mitigation plans are communicated to the first entity through the system by the second entity that provides service to the first entity.

2. The system according to claim 1, wherein the system enables the second entity to provide, to the first entity, access to the system.

3. The system according to claim 1, wherein the system enables the first entity to apply data privacy control settings to at least a portion of the information corresponding to the first entity and the entities that operate in association with the first entity, thereby defining the manner in which such data can be used by the system.

4. The system according to claim 3, wherein the system is configured to refrain from sharing, with at least the second entity, information, that has privacy control settings applied.

5. The system according to claim 3, wherein the system is allowed to use information, that is tagged with the privacy control settings, in a manner that complies with the privacy settings.

6. The system according to claim 1, wherein the risks are based on at least geopolitical events, economic events, extreme weather and natural disasters.

7. The system according to claim 1, wherein the system allows the second entity to administer a risk mitigation plan to address the risk that the first entity is exposed to.

8. The system according to claim 7, wherein the system is configured to provide risk mitigation plans based on one or more of the type of first entity, the type of risk and a type of insurance that covers the risk.

9. The system according to claim 8, wherein the system is configured to customize risk mitigation plans at least based on one or more of the type of first entity, the type of risk and a type of insurance that covers the risk.

10. The system according to claim 7, wherein the system is configured to provide risk mitigation plan based on a preconfigured template.

11. The system according to claim 1, wherein the system is configured to define risks as highly critical and/or not critical based on a threshold value.

12. The system according to claim 11, wherein the system is configured to notify to the first entity about the risks which are highly critical to the operations of the first entity, wherein the notification is communicated to the first entity through the system by the second entity.

13. The system according to claim 11, wherein the system is configured to prioritize risks based on their criticality to the operations of the first entity.

14. The system according to claim 1, wherein the risk mitigation plans are based on one or more of historical risk mitigation plans adopted in a geographical location, historical risk mitigation plans adopted in an industry, and historical risk mitigation plans adopted by the first entity.

15. The system according to claim 14, wherein the system is configured to modify risk mitigation plans.

16. The system according to claim 1, wherein the system determines changing risk profiles for the first entity.

17. A system for identifying, monitoring and mitigating risks, the system comprising:
an enrolment module configured to enable a second entity to enroll a first entity to the system, wherein the first entity is allowed to access the system and share information with the system upon enrollment by the second entity;
a notification module configured to notify the first entity and the second entity of risks that are likely to have an impact on the operation of the first entity;
a database module comprising information corresponding to a plurality of entities, plurality of risks, plurality of risk mitigation plans and plurality of insurance products;
an analytics module configured to determine risks which are critical to the operations of the first entity;
a risk assessment module configured to identify a plurality of risks that are inferred to have an impact on the operation of the first entity, by processing at least a portion of information received or using data sourced from publicly available and other sources; and
a privacy module configured to enable the first entity to control information corresponding to the first entity.

18. The system according to claim 17, wherein the database module comprises one or more of data pertaining to entities and its sub entities, list of risks affecting the first entity and its sub entities, historical data pertaining to risks faced by the first entity, listing of risk mitigation plans adopted to overcome corresponding risks, historic data pertaining to risk mitigation plans adopted as per geographical location to overcome risks, historical data pertaining to risk mitigation plans adopted by a specific industry to overcome risks, historical data pertaining to risk mitigation plans adopted by a specific entity to overcome risks, historic weather data, weather forecast data, climate forecast data, political reporting data, historical claims data, economic reporting data and entity internal status report data.

19. The system according to claim 17, further configured to propose insurance products to entities, wherein,
the insurance product is selected from the database module;
the insurance product is created on-demand based on a type of risk which is not covered under insurance products or insurance product configurations present in the database module;
the insurance product is created based on a type of risk which is not covered under insurance products present in the database module; and
the insurance product is modified using other insurance products present in the database module.

20. A method for identifying, monitoring and mitigating risks, the method comprising:
receiving information corresponding to a first entity and one or more entities that operate in association with the first entity;
identifying a plurality of risks having an impact on the operation of the first entity based on understanding of the second entity's exposure to risk from extreme events by processing at least a portion of the information received;
notifying the first entity of the identified risks, wherein the notification is communicated to the second entity through the system by the second entity;
providing risk mitigation plans to the first entity to mitigate impacts of the risks, wherein the risk mitigation plans are communicated to the first entity through the system by the second entity; and
providing confirmation and resulting outcome of applying the risk mitigation plan application are communicated to the second entity through the system by the first entity that uses the service of the second entity.
